(19) United States
(12) Patent Application Publication
(10) Pub. No.: US 2026/0252605 A1
(43) Pub. Date: Aug. 27, 2026

(54) SYSTEMS AND METHODS FOR OPERATIONAL ASSESSMENT

(71) Applicant: Pearl Operational Design Inc., Toronto (CA)

(72) Inventor: Hazel LORD, Toronto (CA)

(21) Appl. No.: 19/549,240

(22) Filed: Feb. 25, 2026

Related U.S. Application Data
(60) Provisional application No. 63/762,709, filed on Feb. 25, 2025.

(51) Int. Cl. G06F 16/3329

(52) U.S. Cl. CPC G06F 16/33295

(57) ABSTRACT

Systems and methods for performing operational assessment. A plurality of responses to a plurality of operational assessment questions are received. The plurality of responses and the plurality of questions are processed by a machine learning model to generate an operational assessment analysis. The operational assessment analysis is used to generate an operational assessment report.

### CROSS-REFERENCE TO RELATED APPLICATIONS

The present disclosure claims priority to and benefit from U.S. provisional patent application no. 63/762,709, entitled “SYSTEMS AND METHODS FOR OPERATIONAL ASSESSMENT” and filed on Feb. 25, 2025, the entire contents of which are hereby incorporated by reference herein.

### TECHNICAL FIELD

The present disclosure generally relates to systems and methods for operational assessment and in particular to systems and methods for operational assessment using a machine learning model.

### BACKGROUND

Operational assessments are essential tools used to evaluate the effectiveness, efficiency, and overall readiness of systems, processes, or organizations. These assessments serve as a foundation for identifying performance gaps, operational risks, and areas for improvement, ensuring alignment with strategic objectives. Industries ranging from business and healthcare to defense and manufacturing rely on operational assessments to optimize workflows, allocate resources effectively, and improve outcomes. Traditionally, these assessments have been conducted using manual methods, static data, and subjective evaluations. While useful, these approaches are often limited in scalability, accuracy, and the ability to provide real-time insights, especially in dynamic and complex environments.

The increasing complexity of modern operations has highlighted the need for more sophisticated and data-driven approaches to operational assessment. Emerging technologies such as automation, machine learning, and real-time monitoring provide a transformative opportunity to overcome the limitations of traditional methods. By leveraging these technologies, operational assessments can now incorporate continuous data collection, predictive analytics, and adaptive feedback mechanisms. This enables organizations to not only identify inefficiencies more accurately but also to proactively address risks and optimize performance in real-time. Such advancements have applications across diverse fields, including supply chain management, healthcare delivery, military readiness, and production systems, where precision and adaptability are critical to success. In particular, the automation and effectiveness of operational assessment through the use of machine learning models remains limited.

Accordingly, systems and methods that enable the use of machine learning in effective operational assessment remain highly desirable.

### SUMMARY

In accordance with one aspect of the present disclosure, a method of performing operational assessment is provided, comprising: receiving a response to an operational assessment questionnaire comprising a plurality of operational assessment questions; processing the response and the questionnaire with a large language model (LLM) to generate an operational assessment analysis corresponding to the response; and evaluating the operational assessment analysis to generate an operational assessment report.

In some aspects, each of the plurality of operational assessment questions corresponds to one of a plurality of operational assessment categories

In some aspects, the plurality of operational assessment categories comprises value proposition, culture, people, process, technology, data, and combinations thereof.

In some aspects, the plurality of operational assessment questions comprise Boolean response questions, multiple choice questions, score-based questions, short answer questions, or combinations thereof.

In some aspects, the operational assessment report comprises an operational roadmap, an operational plan, operational gaps, operational challenges, a start-stop-continue model, an operational assessment summary, an operational recommendation, or combinations thereof.

In some aspects, the plurality of operational assessment questions corresponds to and is configured for operational assessment at an organization hierarchy level, the organization hierarchy level comprising: an individual, a department, an organization, or combinations thereof; and the operational assessment analysis and the operational report correspond to the organization hierarchy level.

In some aspects, the method further comprises: generating the questionnaire.

In some aspects, the method further comprises: storing the response, the operational assessment analysis, the operational assessment report, or combinations thereof.

In some aspects, the operational assessment analysis comprises an operational assessment rating and/or operational assessment narratives.

In some aspects, the processing comprises: generating a prompt using the response and the questionnaire.

In some aspects, the prompt comprises a system prompt configured to provide processing context for the LLM and/or context for the response and the questionnaire.

In some aspects, the response, the questionnaire and the operational assessment analysis are formatted as JSON.

In some aspects, the response and the questionnaire are transmitted to the LLM as an application programming interface (API) call and wherein the operational assessment analysis is received as a response to the API call.

In accordance with another aspect of the present disclosure, a system is disclosed, comprising one or more processing units configured to perform the method of any of the above aspects.

In accordance with another aspect of the present disclosure, a non-transitory computer-readable medium having computer readable instructions stored thereon is disclosed, which, when executed by one or more processing units, causes the one or more processing units to perform the method of any of the above aspects.

### BRIEF DESCRIPTION OF THE DRAWINGS

Further features and advantages of the present disclosure will become apparent from the following detailed description, taken in combination with the appended drawings, in which:

FIG. 1 depicts a system for performing operational assessment, according to an example embodiment.

FIGS. 2 and 3 depict methods for performing operational assessment using the system of FIG. 1, according to example embodiments.

FIG. 4 depicts an operation flow for using the system of FIG. 1, according to an example embodiment.

FIGS. 5A-5F depict graphical user interfaces of the system of FIG. 1, according to example embodiments.

It will be noted that throughout the appended drawings, like features are identified by like reference numerals.

### DETAILED DESCRIPTION

Although machine learning models have become increasingly popular for use in various industries, their use remains limited and ineffective in the field of operational assessment. As machine learning models can effectively analyze large datasets to derive insights, the present disclosure aims to leverage the capabilities of these models for use in operational assessment.

The present disclosure is directed to systems and methods for performing operational analysis for an organization. A user seeking to perform operational analysis can be provided with a plurality of questions. Each of the questions can correspond to one of a plurality of operational assessment categories. The user can provide responses to the questions, which can be processed by a machine learning model along with the questions. The machine learning model can analyze the responses and the questions to provide an initial operational assessment, such as, but not limited to, a rating or narratives summarizing and/or providing insights with regard to the operational effectiveness and efficiency. Based on the initial operational assessment, an operational assessment report can be generated and provided to the user, which can summarize the assessment findings as well as provide insights and recommendations for improving operations.

Various advantages of the disclosed systems and methods will be apparent through the below description. In particular, the disclosed systems and methods can enable the automatic and efficient processing of large amounts of information to effectively perform operational assessment. Further, the design of the questions can effectively solicit relevant and important information for performing operational assessment.

As used herein, operational assessment can refer to the evaluation of the effectiveness, efficiency, and readiness of entities such as systems, processes, or organizations in achieving their intended objectives. For example, operational assessment for a warehouse may evaluate a degree of organization for the inventory as well as how well human resources are applied for managing incoming and outgoing inventory. Operational assessment can be used for identifying areas for improvement and ensuring alignment of the operations with strategic goals. In particular, operational assessment may include performance evaluation measuring how well operations are meeting desired outcomes or performance benchmarks; identification of strengths and weaknesses to highlight areas of efficiency and pinpoint inefficiencies, bottlenecks, or risks; ensuring readiness by assessing the capability and preparedness of entities such as systems, teams, or processes in handling current and future demands; and improvement recommendations to provide actionable insights to optimize operations, reduce costs, and enhance productivity. Operational assessment can be applied across a variety of industries including business, healthcare, defense, technology, and manufacturing. In particular, operational assessment can be performed to evaluate how effective/efficient organizations are.

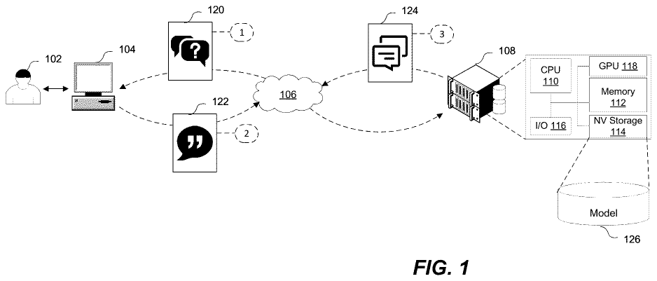

Embodiments are described below, by way of example only, with reference to FIGS. 1-5F.

FIG. 1 depicts a system for performing operational assessment, according to an example embodiment, shown in FIG. 1 as one or more servers 108. The implementation of the servers 108 is not restrictive and servers 108 may be a physical server, cloud-based server, or a hybrid thereof, for example.

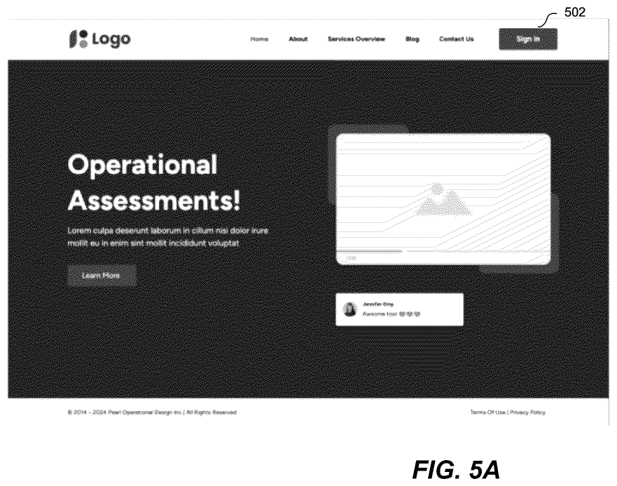

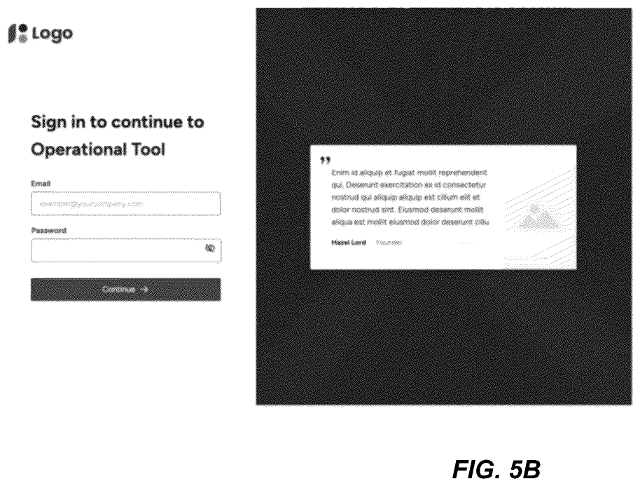

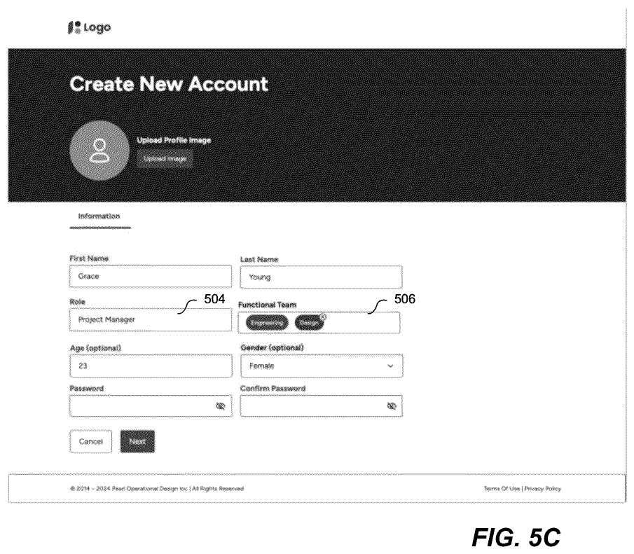

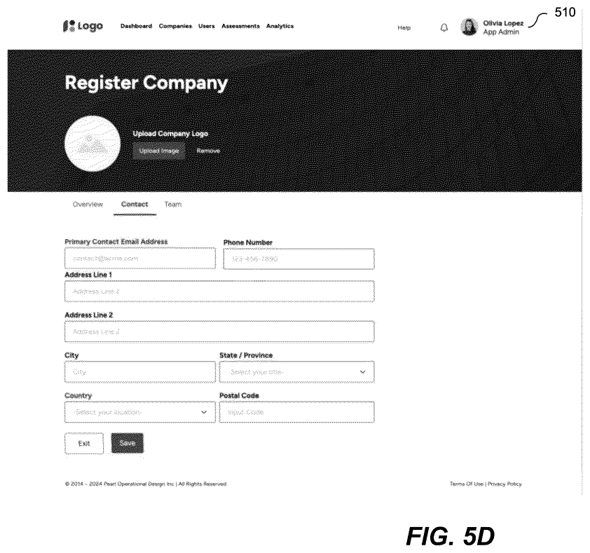

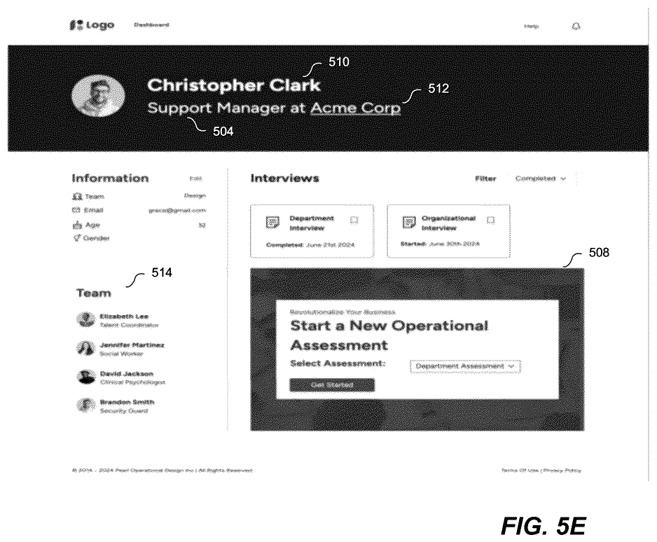

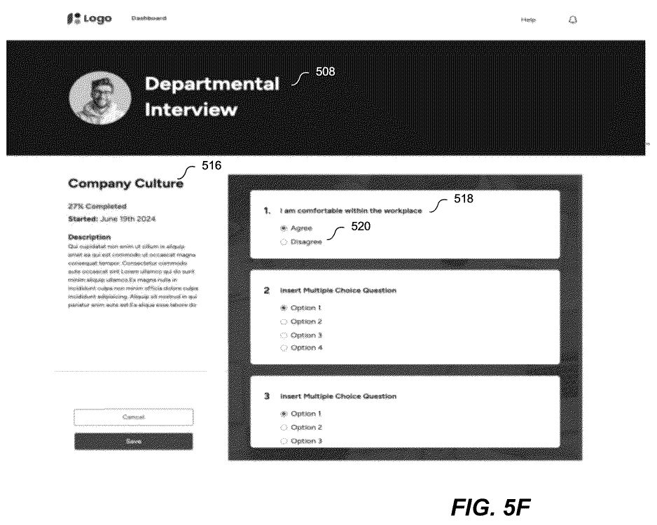

A user 102 may interact with the servers 108 via a device 104 over a communications network 106 (e.g. the internet). The device 104 may be a computer, as depicted in FIG. 1, but is not restricted to those expressly shown and may be any suitable device known in the art such as smartphones, laptops and/or tablets. The servers 108 may provide a graphical user interface (GUI) on the device 104 for ease of communication and operational control by the user. The implementation of the GUI is not restrictive and may be, for example, a mobile/computer application or a web page. Example GUIs for the system are shown in FIGS. 5A-5F and are described further herein. The GUI can be used to provide input to and receive output from the servers 108. Additionally, or alternatively, other user interfaces, such as an audio interface that allows receipt and processing of spoken commands, may be used.

The user 102 may be interested in performing operational assessment via the servers 108. The servers 108 can prompt the user 102 to provide information for performing operational assessment using a questionnaire 120 including a plurality of operational assessment questions. The user 102 can provide responses 122 to the questionnaire 120 to the servers 108. The servers 108 may be configured to process the questionnaire 120 and the responses 122 to perform operational assessment. In particular, the questionnaire 120 and/or the responses 122 may be processed by at least one machine learning model 126 to generate operational assessment analysis. The servers 108 may also be configured to process the generated operational assessment analysis to generate an operational assessment report 124, as described further herein. The machine learning models 126 may each be an artificial intelligence (AI) model or algorithm, a neural network, a machine learning model or algorithm, and may each be, in particular, a large language model (LLM). The operational assessment report 124 may be returned to the user 102 from the server 108 to the device 104 for display, for example over the communications network 106.

According to the present disclosure, the responses 122 may be provided to or retrieved by the servers 108, for example, from the device 104. The responses 122 can also be retrieved from one or more external devices and/or one or more databases, for example in a case where the responses 122 have been completed at a different time (e.g. where the questionnaire 120 was previously distributed). The databases may be accessible by the servers 108 or the device 104 or coupled thereto, for example over the communications network 106. In at least some embodiments, the databases include an external database hosted on an external server. The questionnaire 120 and/or responses 122 may be requested and received using an application programming interface (API) via requests/calls and responses, for example over the communications network 106, although other forms of communication such as Bluetooth and near-field communication are possible as well.

In some embodiments, the operational assessment analysis and the operational assessment report 124 may be transmitted to and displayed at a second device, for example for the second user. The second device is analogous to the device 104 and the exchange of data between the second device and the servers 108 is conducted analogously. In particular, the second user may be a solicitor, or a responsible person for the user 102 and/or organization of the user 102. For example, the user 102 may belong to a group of users or an organization having a plurality of users, and the second user may be a manager of the group of users or the organization. The second user may then use the servers 108 to collect responses 122 from the users of the group or the organization in order to perform operational assessment for the group or the organization. Accordingly, the operational assessment analysis and the operational assessment report 124 can be provided to the second user as the assessment result.

In a particular implementation, the servers 108 each comprise a central processing unit (CPU) 110, a non-transitory computer-readable memory 112, a non-volatile storage 114, an input/output interface 116, and a graphics processing unit (“GPU”) 118. The non-transitory computer-readable memory 112 comprises computer-executable instructions stored thereon at runtime which, when executed by the CPU 110, configure the server to perform the above-described processes of operational assessment. The non-volatile storage 114 has stored on it computer-executable instructions that are loaded into the non-transitory computer-readable memory 112 at runtime. The input/output interface 116 allows the servers 108 to communicate with one or more external devices such as the device 104. The non-transitory computer-readable memory 112 may also have stored thereon the machine learning models 126. The GPU 118 may be used to control a display and may be used to process the responses 122 and to generate the operational assessment analysis and the operational assessment report 124. In some embodiments, the machine learning models 126 may be stored within one or more separate servers. In such cases, the servers 108 can be communicatively coupled to the machine learning models 126 to process the responses 122. Accordingly, it is possible to interface with the models 126 through the use of APIs. For example, API requests and responses can be used to transmit the responses 122 to and receive the operational assessment analysis from the machine learning models 126. The servers 108 and the device 104 may each provide a communications interface which allows software and data to be transferred, for example between the servers 108 and the device over the communications network 106.

The CPU 110 and GPU 118 may be one or more processors or microprocessors, which are examples of suitable processing units, which may additionally or alternatively comprise an artificial intelligence accelerator, programmable logic controller, a microcontroller (which comprises both a processing unit and a non-transitory computer-readable medium), AI accelerator, neural processing unit (NPU), or system-on-a-chip (SoC). As an alternative to an implementation that relies on processor-executed computer program code, a hardware-based implementation may be used. For example, an application-specific integrated circuit (ASIC), field programmable gate array (FPGA), or other suitable type of hardware implementation may be used as an alternative to or to supplement an implementation that relies primarily on a processor executing computer program code stored on a computer-readable medium.

It should be noted that while FIG. 1 depicts the device 104 and the servers 108 as separate entities coupled over the communication network 106, the device 104 and servers 108 may also be coupled directly/physically using cable(s) for data transfer. In some embodiments, the servers 108 may also be the device 104 or comprise the device 104 (e.g. the servers 108 being implemented as a part of a computer system). In such an embodiment, the servers 108 may directly retrieve the responses 122 (as well as any other required data) from fixed local storage or removable local storage.

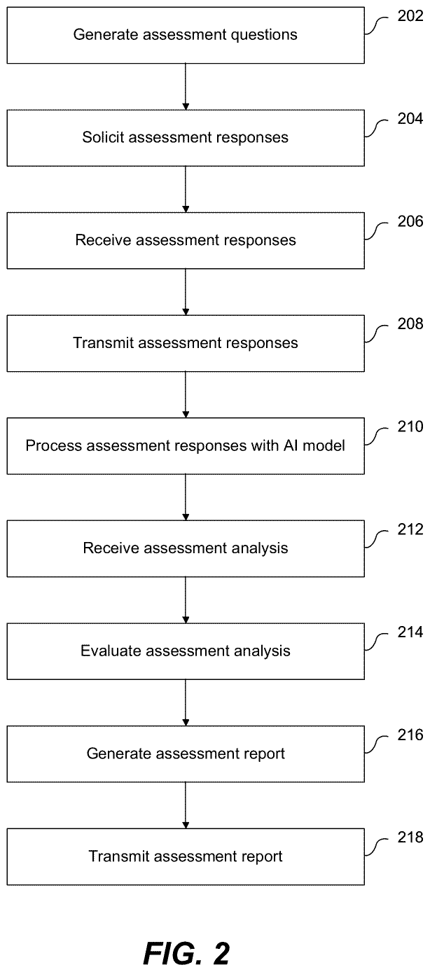

FIG. 2 depicts a method for performing operational assessment. As an example, an individual (such as the user 102) can perform the depicted operational assessment method for an organization. At 202, a plurality of operational assessment questions can be generated, corresponding to questions 120 in FIG. 1. The questions can be used to evaluate operational effectiveness and efficiency of an organization, such as a company, group, collection of people, etc. The goal of the questions can be to solicit information from a respondent that is useful or relevant for performing operational assessment. In some embodiments, each of the questions can correspond to (e.g. grouped into) one or more operational assessment categories. Each category can correspond to an aspect of operational efficiency/effectiveness pertinent to the performance of operational assessment.

A list of non-limiting categories can include one or more of: value, culture, people, process, technology, and data. The value category can correspond to how meaningful, useful, or valuable an aspect of the operation is. For example, an aspect can be a goal, a purpose, an effectiveness, or an efficiency of the operation. The value category can also be used to evaluate how well an aspect of the operation aligns with the goals of the respondent/organization. An example question in this category can be: “How well does my work impact department goals?” The culture category can correspond to the work culture as well as the organization values. An example question in this category can be: “Do I know what my organizational values are?”. The people category can correspond to the utilization of human resources in the organization, information with regard to the individual responding to the question as well as their role/contribution in the context of the organization. An example question in this category can be: “Am I trusted to do my job?” The process category can correspond to the design and execution of workflow and tasks in the organization. An example question in this category can be: “How well do people follow processes to do their work?” The technology category can correspond to the use of technology in the organization and effectiveness thereof. An example question in this category can be: “Is technology embraced as a useful tool?” The data category can correspond to the amount, value, and type of data that is available and used in the organization as well as how the data is utilized. An example question in this category can be: “Do I trust the data I have access to?”

Each of the questions can be formulated in multiple ways. The questions can comprise multiple choice questions, Boolean questions, score/rating questions, and/or short answer questions. Multiple choice questions provide a number of allowed responses for the respondent to select from, for example, a question may be: “how many people are in the organization?” where the possible response choices are: a) less than 10; b) between 10 and 15; or c) more than 15. Boolean questions prompt the respondent to provide one of two possible options (e.g. True/False, agree/disagree). Score/rating questions can prompt the user to provide a numerical rating (e.g. in a range), which may be selected as one of a number of options or as a raw number entry. An example question may be: “Rate how experienced I am with the work I am doing between 1 to 5, where 5 is very experienced”, where the possible responses may be a selection of a rating between 1 to 5. Short answer questions can prompt the respondent to respond to the question using natural language, which can provide more information than the other question types.

In some embodiments, each of the questions can also correspond to an organization hierarchy level. The organization hierarchy level can correspond to a subset of the organization or a section/group within the organization. For example, the hierarchy level can be an individual, a section of the organization (e.g. a department), or the entire organization. Questions corresponding to a particular hierarchy level can be useful in gathering information to determine operational effectiveness and efficiency at the particular hierarchy level.

The questions may be created by one or more operational assessment specialists and may also be generated using machine learning models such as LLMs. For example, a LLM can be prompted to provide questions that would assess the operational effectiveness and efficiencies in one or more of the categories. The questions may be stored in a database, for example in association with the user and/or organization where the system can retrieve questions as needed. Further, additional questions may be added to the database as required. Similarly, questions deemed outdated or no longer useful can be removed from the database.

At 204, the user 102 is prompted to provide information useful in performing operational assessment by requesting the user 102 to respond to the questions, where the responses to the questions correspond to responses 122 in FIG. 1. In particular, a collection of questions can be formulated as a questionnaire for the user 102 to respond to. The questions can be provided to the user 102 using a GUI, for example implemented as a webpage or application. In some embodiments, questions can be presented to the user 102 in series (e.g. one by one). Accordingly, a subsequent question (e.g. the next question) can be based on the response to a prior question (e.g. previous question). For example, a first question may be used to determine the number of employees in an organization. If the response to the first question indicates that there are a large number of employees in the organization, the next question in the series may be selected as how many employees are in each section of the organization. However, if the response to the first question is that there are very few employees in the organization, the second question may be omitted. The responses to the questions can also be stored in a database. In addition to responding to the questions, the user 102 may also be prompted to provide additional information not used for operational assessment as profile information (e.g. name, age, sex, etc.) as well as organization information (e.g. name, type of organization, location, etc.), which can also be stored.

In some embodiments, the responses to the questions may be received via an audio input. The audio input may then be stored as an audio file which is converted to text by the system. Alternatively, the audio input may be converted to text as the audio input is received such that the system then stores the text file corresponding to the audio input in a real-time manner. In some embodiments of real-time text conversion, the audio input may also be stored and associated with the text conversion file so that a check can be performed to ensure that the text matches the audio.

At 206, the responses are received/retrieved from the user 102 or a device thereof, for example over the communications network 106.

In some embodiments, each question may be assigned a question identifier. The identifier can facilitate tracking of questions and corresponding responses, as well as the assigning of the question to users, as different users may be assigned different questions in the questionnaire. As such, the questionnaire can be generated by listing the questions by their identifiers for ease of formulation. Each question may also be assigned a number for the sequence/position of the question in the questionnaire.

At 208, the responses and the corresponding questions can be transmitted to the machine learning model 126 as a part of a prompt for analysis. In particular, the machine learning model can be a LLM, which is trained to process natural language inputs and to provide natural language outputs. The machine learning model can be an LLM such as, but not limited to, ChatGPT™ and Copilot™, or another suitable neural network or machine learning model. The machine learning model can be pretrained and accordingly only used for inference, as described herein. In some embodiments, after the collection of data from user responses, the machine learning model can be trained using this data.

The machine learning model can be implemented as a part of the system of FIG. 1 in which case the responses and questions can be processed by the machine learning model directly. Alternatively, the machine learning model may be hosted on a separate server and as such, the prompt including the responses and the corresponding questions may be formulated as an API call to the machine learning model. Data input to the machine learning model (e.g. the prompt) may be formatted prior to being processed by the machine learning model. For example, if the input needs to be formulated as an API call, the input may be processed into JSON format. In at least some embodiments, the questions are input to the LLM as JSON. Each question may be an individual JSON object or all of the questions may be a single JSON object or array.

In some embodiments, the system may also include the functionality whereby dummy accounts may be set up with links sent to individuals (associated with the dummy accounts) whereby the individual can log on to the system and providing input to the system without needing to set up an account. This reduces the burden on individuals from having to go through an on-boarding process.

The prompt can also provide additional context to the machine learning model. In particular, the prompt can comprise additional context for each of the responses and questions. Context for the questions can correspond to the type of question as well as the possible responses. For example, the prompt can indicate that a question is a multiple-choice question as well as the given choices for each of the options in the multiple-choice question. Context for the responses can correspond to a preference for one or more response options. For example, for a true or false question, the prompt can indicate that one of the options is preferable (e.g., True is preferable). As another example, for a rating question, the prompt can indicate that a higher rating is preferable. In some embodiments, additional context such as the purpose of the question or the type of insights that is desired from the question/response may be included in the prompt as well. The prompt can be generated based on a given format, where placeholders are replaced with the appropriate question, response, and context. An example prompt is shown below as a template:
number: Question number.
question: The text of the question
type: “Multiple Choice” or “Agree/Disagree”
respondent_answer: The respondent's answer
ideal_answer: The expected answer
additional_context: Extra information, if applicable.
   In the above example, “Question number”, “The text of the question”, “Multiple Choice”, “Agree/Disagree”, “The respondent's answer”, “The expected answer”, and “Extra information, if applicable” are placeholders replaced with the appropriate information prior to being input to the machine learning model. An example of the same prompt in JSON format is shown below:
{“number”: 1, “question”: “I am aware of the accountabilities of my department.”, “type”: “agree/disagree”, “respondent_answer”: “agree”, “ideal_answer”: “agree”, “additional_context”: null}.

In some embodiments, the prompt can also comprise a system prompt for providing the machine learning model with background, context, or a role for interpreting the questions and responses. For example, a system prompt can comprise a high-level description of the task that it needs to perform, such providing operational analysis in a particular field. The system prompt may also differ depending on the organization hierarchy level of the question/response or groups thereof. In particular, the system prompt can identify a role (e.g. business consultant) and the organization hierarchy level based on which analysis should be performed.

An example system prompt for an individual level operational assessment can be: “You are an expert business consultant tasked with reviewing a questionnaire completed by a respondent. The questionnaire is divided into sections, each with proprietary names and context about its importance.”

An example system prompt for a section level operational assessment can be: “You are an expert business consultant tasked with reviewing assessments of individuals working within the same department. Use these to generate a comprehensive assessment of the department.” For section level operational assessment, the system prompt may also instruct the machine learning model to focus on section-level analysis. For example, the system prompt can include instructions such as “Focus on department-wide insights rather than individual feedback. Keep your analysis clear, concise, and solution-oriented.”

An example system prompt for an organization level operational assessment can be: “You are an expert business consultant tasked with generating a comprehensive assessment of an entire organization based on the departmental assessments provided. Your report should clearly summarize the key findings and provide insights at the organizational level.”

As described above, the LLM can be prompted to perform the analysis according to the hierarchy level. In particular, the specified hierarchy level can be one of a plurality of hierarchy levels, as described above. In some embodiments, the LLM can generate the operational assessment analysis for the prompted hierarchy level for all questions. Alternatively, the hierarchy level can be specified on a per-question basis or for groups of questions.

The system prompt can also provide additional context for the operational assessment that the machine learning model is prompted to perform. In particular, the system prompt can outline one or more evaluation criteria or output. The evaluation criteria can include, but is not limited to:
1. Overall Alignment: Assessment of the collective alignment of the organization/section with preferred answers, where common strengths and areas where the group diverges from expectations can be requested to be highlighted.
2. Patterns & Trends: Identify recurring themes, patterns, and trends in responses that indicate organization/section-wide behaviors, attitudes, or challenges.
3. Departmental Strengths & Weaknesses: Highlight key areas where the organization/section excels, where it requires improvement, and risks of not addressing high risk areas.
4. Actionable Recommendations: Provide specific, practical recommendations for the organization/section to address gaps, enhance performance, and align more closely with organizational goals. Based on responses provided and the compiled assessments, predictions of potential barriers to achieving organization goals, risk to department and organizational culture and outcomes and suggest solutions to mitigate and manage risk. Provide a visualization model of responses per category by department/role.
5. Overview: Summarize the overall alignment of the organization/section with preferred responses. Highlight areas where the company excels and where it faces challenges across departments.
6. Departmental Patterns: Identify trends and themes observed across multiple organizations/sections. Highlight any systemic issues or strengths impacting the entire organization/section.
7. Strengths & Areas for Improvement: Provide an overview of the organization's/section's key strengths and opportunities for growth. Focus on areas that affect company-wide performance and alignment with goals.
8. Actionable Recommendations: Offer strategic recommendations for the organization/section as a whole to address systemic gaps, improve operational efficiency, and align more closely with its objectives.

In some embodiments, items 1-4 can form a part of the system prompt for section level operational assessment and items 5-8 can form a part of the system prompt for organization level operational assessment.

The prompt to the machine learning model should also outline the task to be performed. In particular, the prompt can instruct the machine learning model to output narratives corresponding to the operational assessment analysis. The narratives can comprise a summary of the operational assessment (e.g. summary of operational efficiency/effectiveness), insights/key findings from the responses with respect to operational assessment, recommendations for improving operational effectiveness/efficiency, and other relevant information. The narratives can be output by the machine learning model in natural language. The prompt can also instruct the machine learning model to output a score corresponding to the operational assessment. The score can be a number value representing the results of the operational assessment, for example corresponding to the operational efficiency/effectiveness of the organization determined by the machine learning model. The prompt can also define a scoring system to serve as the basis for the operational assessment (e.g. the score). The scoring system can comprise weights which rewards/penalizes certain questions/responses based on one or more criteria. For example, certain types of questions (e.g. multiple-choice questions); questions from a particular category; certain types of responses (e.g. responses of “False” or “Disagree”) may be assigned a higher/lower weight for determining the score. An example prompt defining the task (e.g. operational assessment) to be performed by the machine learning model can be: “Your task is to evaluate the respondent's answers, provide an assessment and score according to *proprietary scoring system*” or “At the end of the assessment, provide a score according to *proprietary scoring system*”.

At 210, the prompt including the questions and the responses is processed by the machine learning model to generate the operational assessment analysis including the narratives and/or score. In some embodiments, the questions may be processed in series. That is, the LLM can generate an operational assessment analysis for each question or for a group of questions. Alternatively or additionally, the operational assessment analysis may be performed and generated for all of the questions.

At 212, the generated operational assessment analysis is returned. For example, if the prompt is given to the machine learning model as an API call, the operational assessment analysis can be returned as the API response. Additionally, if the operational assessment analysis is in JSON format, relevant data corresponding to the narratives and the score can be extracted. In at least some embodiments, the operational assessment analysis is also output from the LLM in JSON, where each operational assessment analysis can be output as a JSON object. Once received, the operational assessment analysis can be stored in a database in association with the user and/or organization.

In some embodiments, the tool may allow users to complete a Role Competency Assessment (RCA) based on their role within the organization. This functionality may be provided by a module that can be seen as a structured evaluation tool, used to measure the skills, knowledge, behaviour, effectiveness and experience of an individual against specific job requirements/competencies. The module or tool may also identify skill gaps for targeted training, enhance hiring accuracy, supporting talent management, succession planning, and performance improvement to support the operational assessment.

In use, individuals or users input values based on a given scale (ie: 1-5), for every competency required for a particular role. Some individuals may also input ratings to support the assessment. The tool calculates a competency score based on values provided and generates a RCA. The RCA may also include a project and task demand section which matches competency with work demand to determine if training, or additional resources are required.

At 214, the operational assessment analysis can be evaluated or reviewed to ensure that the content is logical and coherent in the context of the questions/responses. The operational assessment can also be reviewed and modified to remove any potentially sensitive, private, or irrelevant information. Further, the narratives may be modified to better reflect the operational effectiveness/efficiency based on the questions/responses. At 216, the operational assessment report 124 can be generated based on the operational analysis, corresponding to findings from and recommendations based on the operational assessment. The operational assessment report 124 can comprise the operational assessment analysis (e.g. the narratives and/or score). The operational assessment report 124 can also comprise an operational roadmap (e.g. outlining steps for operational improvements), an operational plan (e.g. new or improved operational processes, systems, etc.), operational gaps/weaknesses, operational challenges, a start-stop-continue model corresponding to the operational assessment identifying actionable items that should be improved or redesigned (e.g. started, stopped, or continued), an operational assessment summary, and an operational recommendation. The operational assessment report 124 can also be stored in a database in association with the user and/or organization. At 218, the operational assessment report 124 can be presented to the user 102 (e.g. displayed on the GUI, transmitted as a mail/message, downloaded by the user, etc.).

It should be noted that the databases described above can each be a cloud-based database, such as, but not limited to, Google cloud FireStore™.

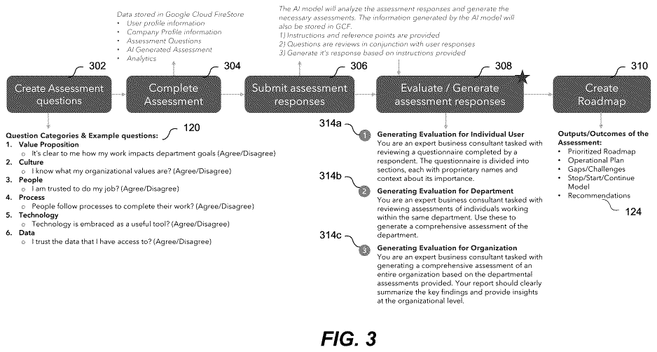

FIG. 3 depicts another representation of a method for performing the operational assessment. At 302, a plurality of operational assessment questions 120 are generated. Each of the questions 120 can correspond to one of a plurality of assessment categories, as described above. At 304, the user 102 receives and completes the questions 120 and submits the responses 122 to the questions 120 at 306. The user 102 can also view analytics for the submitted operational assessment, such as visual representations of the responses 122. At 308, the machine learning model processes the questions 120 and the responses 122 to generate the operational assessment analysis. As shown in FIG. 3, the operational assessment analysis can be generated for one or more organization hierarchy levels such as individual (314a), a section (314b), and an organization (314c). At 310, the operational assessment report 124 can be generated and provided to the user 102.

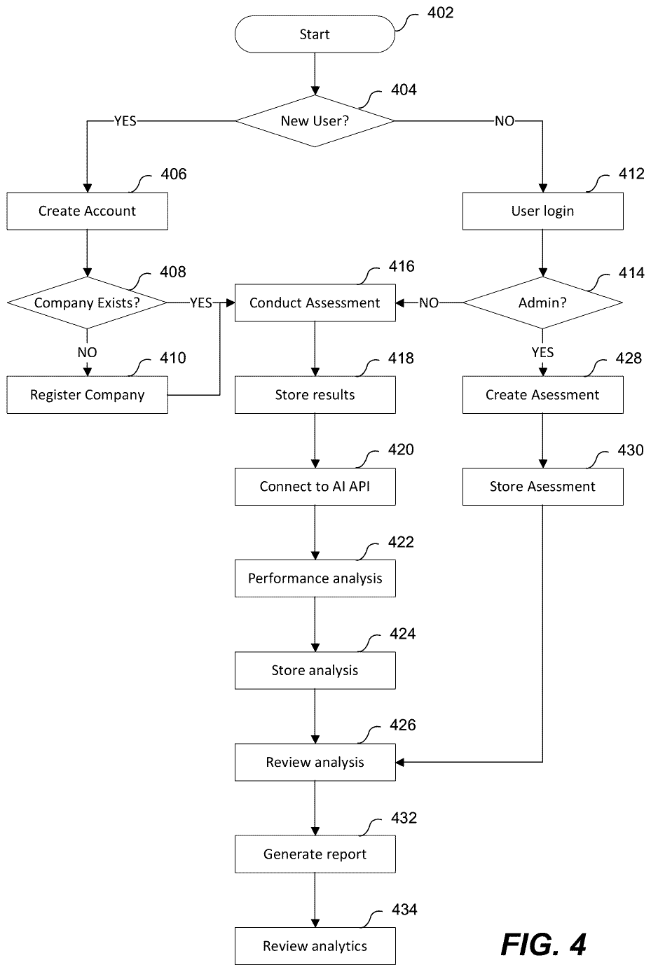

FIG. 4 depicts a workflow for generating an operational assessment report 124 using the system of FIG. 1. The workflow starts at 402, where the user 102 can interact with the system, for example using a GUI. At 404, the system prompts the user 102 to determine if they are a new or existing user. If the user 102 is a new user (YES at 404), the user 102 is prompted to create a new account and required to provide the necessary information to register the new account. The user 102 can belong to or would like to perform an operational assessment for an organization or company. If the organization is not present (NO at 408) in the system's database (e.g. a new organization that is not registered), the user 102 can be prompted to register the organization by providing the necessary information at 410, before beginning the operational assessment at 416. If the organization has already been registered (YES at 408), the user 102 can select the appropriate organization such that the information provided by the user 102 such as the responses 120 can be associated with the organization. If the user 102 is an existing user (NO at 404), they can login to the system using their credentials at 412. If the user 102 is not an admin or superuser (NO at 414), they can elect to be prompted to begin the operational assessment at 416.

At 416, the user 102 can conduct the operational assessment by providing responses 122 to the questions 120, presented by the system. The responses 122 can be stored at 418, for example in association with the questions 120, the user 102, and the organization. At 420, the system can communicate with one or more machine learning models using an API gateway, for example by formulating a prompt using the responses 122 and the questions 120 as an API request. At 422, the one or more machine learning models performs operational assessment by processing the responses 122 and the questions 120 to generate an operational assessment analysis. The generated operational assessment analysis can be returned, for example as an API response. The operational assessment analysis can be stored at 424, for example in association with the questions 120, the user 102, and the organization. At 426, the operational assessment analysis can be reviewed and evaluated before generating the operational assessment report 124 based on the operational assessment analysis (432). The operational assessment report 124 can be provided or presented to the user 102. The operational assessment report can also be stored, for example in association with the questions 120, the user 102, and the organization. At 434, the user can review the analytics for the operational assessment, such as a summary of results from other members of the organization, a summary of the operational assessment for the organization, as well as comparisons thereof to other organizations.

If the user 102 is an admin (YES at 414), for example if the user is a representative from the organization or an admin of the system, the user 102 can create the assessment questions 120 at 428. The created questions 120 can be stored at 430 for conducting operational assessment for other users. The admin user can also view (e.g. review and evaluate) the operational assessment results for other users, for example the operational assessment analysis generated at 424.

FIGS. 5A-5F depict various GUIs for the system of FIG. 1, shown as various webpages. FIG. 5A depicts a landing page for a user (510) that has interfaced with the system where they can login using the button 502 if they are an existing user (e.g. NO at 404). Upon clicking the button 502, the user (510) can be taken to the login page shown in FIG. 5B. FIG. 5C depicts a signup page for new users (e.g. YES at 404). As shown in FIG. 5C, aside from basic information such as name and login credentials, the user (510) may be requested to input their role 504 in the organization as well as section(s) 506 of the organization (510) they operate in. FIG. 5D depicts an organization registration page (e.g. NO at 408). The user 510 can provide basic information for the registration of the organization (510). FIG. 5E depicts a user dashboard page. As shown in FIG. 5E, the user 510 is associated with their role 504 and their organization 512. Other members (514) of the same section or organization may also be associated with the user 510. The user 510 can conduct operational assessment 508 by starting one or more questionnaires. FIG. 5F depicts a response page corresponding to the user 510 conducting the operational assessment 508. The user 510 is presented with a plurality of questions 518 to which they have provided responses 520. The question 518 can correspond to a particular category of questions 516.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification, so long as such those parts are not mutually exclusive with each other.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components. Further, as used herein, the term “comprising” can mean “including.” Variations of the word “comprising”, such as “comprise” and “comprises,” have correspondingly varied meanings. Thus, for example, a composition “comprising” X may consist exclusively of X or may include one or more additional unrecited components. It will be understood that in embodiments which comprise or may comprise a specified feature or variable or parameter, alternative embodiments may consist, or consist essentially of such features, or variables or parameters. A reference to an element by the indefinite article “a” does not exclude the possibility that more than one of the elements is present, unless the context clearly requires that there be one and only one of the elements.

Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

The terms are not to be interpreted to exclude the presence of other features, steps or components. Further, the singular forms “a”, “an”, and “the” are intended to include the plural forms as well, unless the context clearly indicates otherwise.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present. Further, in this disclosure, the term “or” is generally employed in its sense including “and/or” unless the content clearly dictates otherwise.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied herein disclosed may be resorted to by those skilled in the art, and that such modifications and variations are considered to be within the scope of this invention.

1. A method of performing operational assessment, comprising:
receiving a response to an operational assessment questionnaire comprising a plurality of operational assessment questions;
processing the response and the questionnaire with a large language model (LLM) to generate an operational assessment analysis corresponding to the response; and
evaluating the operational assessment analysis to generate an operational assessment report.

2. The method of claim 1, wherein each of the plurality of operational assessment questions corresponds to one of a plurality of operational assessment categories.

3. The method of claim 2, wherein the plurality of operational assessment categories comprises value proposition, culture, people, process, technology, data, and combinations thereof.

4. The method of claim 1, wherein the plurality of operational assessment questions comprises Boolean response questions, multiple choice questions, score-based questions, short answer questions, or combinations thereof.

5. The method of claim 1, wherein the operational assessment report comprises an operational roadmap, an operational plan, operational gaps, operational challenges, a start-stop-continue model, an operational assessment summary, an operational recommendation, or combinations thereof.

6. The method of claim 1,
wherein the plurality of operational assessment questions corresponds to and is configured for operational assessment at an organization hierarchy level, the organization hierarchy level comprising: an individual, a department, an organization, or combinations thereof; and
wherein the operational assessment analysis and the operational report correspond to the organization hierarchy level.

7. The method of claim 6, wherein the LLM is prompted to generate the operational assessment analysis for one of a plurality of organization hierarchy levels.

8. The method of claim 1, further comprising: generating the questionnaire.

9. The method of claim 1, further comprising: storing the response, the operational assessment analysis, the operational assessment report, or combinations thereof.

10. The method of claim 1, wherein the operational assessment analysis comprises an operational assessment rating and/or operational assessment narratives.

11. The method of claim 10, wherein the LLM is prompted to generate the operational assessment rating according to a scoring system for assessing the response.

12. The method of claim 1,
wherein the processing comprises: generating a prompt using the response and the questionnaire; and
wherein the prompt comprises a system prompt configured to provide processing context for the LLM and/or context for the response and the questionnaire.

13. The method of claim 12, wherein the context comprises: a question type, acceptable responses, a preferable response, or combinations thereof.

14. The method of claim 1,
wherein the response, the questionnaire and the operational assessment analysis are formatted as JSON; and
wherein the LLM processes the questionnaire as JSON and outputs the operational assessment analysis as JSON.

15. The method of claim 1, wherein the response and the questionnaire are transmitted to the LLM as an application programming interface (API) call and wherein the operational assessment analysis is received as a response to the API call.

16. The method of claim 1, further comprising: transmitting the questionnaire to a first user device using API; wherein the response is received from the first user device using API.

17. The method of claim 1, further comprising: transmitting the operational assessment analysis and/or the operational assessment report to a second user device using API.

18. The method of claim 1, wherein the operational assessment analysis comprises an analysis for each of the plurality of operational assessment questions.

19. A system comprising one or more processing units configured to perform the method of claim 1.

20. A non-transitory computer-readable medium having computer readable instructions stored thereon, which, when executed by one or more processing units, causes the one or more processing units to perform the method of claim 1.
